(19) United States
(12) Patent Application Publication
(10) Pub. No.: US 2007/0206513 A1
(43) Pub. Date: Sep. 6, 2007

(54) Method for selecting root bridge in configuration of spanning tree

(75) Inventors: Jae-Hun Cho, Seoul (KR); Seong-Taek Hwang, Pyeongtaek-si (KR); Hoon Kim, Suwon-si (KR); Sihai Wang, Suwon-si (KR); Jong-Ho Yoon, Goyang-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/642,572

(22) Filed: Dec. 20, 2006

(30) Foreign Application Priority Data
Mar. 3, 2006 (KR) 2006-20665

(51) Int. Cl. H04L 12/28; H04L 12/56

(52) U.S. Cl. 370/254; 370/401; 370/408

(57) ABSTRACT

Disclosed is a method, apparatus and computer-readable medium for selecting a root bridge when a spanning tree is configured in an Ethernet network including a plurality of legacy switches and a plurality of synchronous switches. The method comprises the steps of providing in advance identification information in a configuration BPDU message of the synchronous switch, the identification information representing that a corresponding switch is an AV switch, broadcasting configuration BPDU messages by the legacy switches and the synchronous switches; and receiving configuration BPDU messages by the synchronous switch from other switches, confirming bridge priorities according to the synchronous switches through the received configuration BPDU message and the identification information to select a synchronous root bridge, receiving configuration BPDU messages by the legacy switch from other switches, and confirming bridge priorities through the received configuration BPDU messages to select a legacy root bridge.

### CLAIM OF PRIORITY

This application claims the benefit of the earlier filing date, pursuant to 35 USC 119, to that patent application entitled “Method For Selecting Root Bridge In Configuration Of Spanning Tree,” filed in the Korean Intellectual Property Office on Mar. 3, 2006 and assigned Serial No. 2006-20665, the contents of which are hereby incorporated by reference.

### BACKGROUND OF THE INVENTION

1. Field of the Invention

The present invention relates to an Ethernet network, and more particularly to a method for selecting a root bridge in an Ethernet network when a spanning tree is configured.

2. Description of the Related Art

Ethernet is technology which is the most universally and familiarly accessible when data is exchanged among different terminals. However, Ethernet has been known as a technology not suitable for multimedia data transmission because of multimedia data sensitive to transmission time delay. Recently, technology has been actively discussed, which can transmit multimedia data, including images and voice, while being compatible with existing Ethernet. Such technology is being currently standardized in an Institute of Electrical and Electronics Engineers (IEEE) 802.1, which is referred to herein as Audio Video (AV) bridging or residential bridging.

FIG. 1 is an exemplary view illustrating the general construction of an Ethernet network including a plurality of bridges. As illustrated in FIG. 1, an Ethernet network may include a plurality of Local Area Networks (LANs) referred to as LAN A to LAN E, to which a plurality of terminating devices (not shown) are respectively connected, and a plurality of bridges 101 to 105 providing connections among the illustrated LANs. For example, a message transferred may be bridged from one LAN to any of the other LANs according to an IEEE 802.1D standard stipulating Media Access Control (MAC) bridging.

In the network connected by the bridges as described above, if a multipath exists among certain bridges, a loop is formed and thus a message sent from one bridge may be repeatedly circulated along the loop. In order to prevent this problem, only one path must principally exist between certain two bridges (in FIG. 1, a third bridge 103 and a fourth bridge 104, etc.). Accordingly, each bridge supports a Spanning Tree Algorithm (STA) for executing a Spanning Tree Protocol (STP) based on an IEEE 802.1D standard, thereby preventing a loop from being generated.

An STP currently standardized in an IEEE 802.1D protocol is a protocol for an existing bridge, i.e. a legacy bridge, supporting only best effort traffic, and blocks one of two bridges to prevent a loop from being generated. To this end, bridges negotiate with one another to allow only one of two bridges to be activated. Further, an STA prevents a loop from being generated among bridges in a network connected by the bridges, selects the most economic path, and forwards a message through the path.

FIG. 2 is a block diagram illustrating the Ethernet network of FIG. 1 using a spanning tree structure. In order to configure the spanning tree as illustrated in FIG. 2, information is exchanged through a spanning tree configuration message broadcasted by a bridge, i.e. a configuration Bridge Protocol Data Unit (BPDU) message.

A spanning tree based on a root bridge (a first bridge 101 in FIG. 2) is configured by using such a configuration BPDU message. As illustrated in FIG. 2, the root bridge is a bridge located at the top of the spanning tree. It is most probable that communication among bridges will be performed via the root bridge. Each bridge determines a port to be disabled through a BPDU message exchanged therebetween. In an IEEE 802.1D protocol, a disabled port is defined as a blocking state and an enabled port is defined as a forwarding state. The configuration BPDU message includes a root Identification (ID), a root path cost, a transmission bridge ID, etc.

The root ID is an identifier of a bridge considered as a root bridge located in the center of a logical tree bridge topology configured in order to compute a spanning tree path. In the course of configuring a spanning tree, the root ID is gradually converged to one value. The path cost has a priority value recommended according to traffic transmission speed as illustrated in table 1. The transmission bridge ID is an identifier of a bridge transmitting the configuration BPDU message, and a unique ID such as a MAC address is allocated to each bridge.

TABLE 1
Root Path Cost Parameter

| | Connection | | Recommended | Recommended | Allocable |
|---|---|---|---|---|---|
| Parameter | speed | | value | range | range |
| Path cost | 4 | Mb/s | 250 | 100 to 1000 | 1 to 65535 |
| Path cost | 10 | Mb/s | 100 | 50 to 600 | 1 to 65535 |
| Path cost | 16 | Mb/s | 62 | 40 to 400 | 1 to 65535 |
| Path cost | 100 | Mb/s | 19 | 10 to 60 | 1 to 65535 |
| Path cost | 1 | Gb/s | 4 | 3 to 10 | 1 to 65535 |
| Path cost | 10 | Gb/s | 2 | 1 to 5 | 1 to 65535 |

As illustrated in table 1, the path cost includes values recommended according to bandwidths and allocable ranges. In the recommended value, 250 is set for a link speed of 4 Mbps, 100 is set for a link speed of 10 Mbps, 62 is set for a link speed of 16 Mbps, 19 is set for a link speed of 100 Mbps, 4 is set for a link speed of 1000 Mbps, and 2 is set for a link speed of 10000 Mbps. The allocable range is set from 1 to 65535.

A selection process of a root bridge will now be described in more detail. Each bridge initially considers itself a root bridge, employs a root ID as its own bridge ID, i.e. a transmission bridge ID, and broadcasts a configuration BPDU message to all ports. Then, each bridge receives such a configuration BPDU message from each port, and compares the root ID value of the received configuration BPDU message with its own root ID value. When the root ID value of the received configuration BPDU message is greater than the root ID value. i.e. when the root ID value has a higher priority, each bridge drops the received configuration BPDU message, and continues to transmit its own configuration BPDU message. However, when the root ID value of the received configuration BPDU message is smaller than the root ID value, each bridge stops transmitting its own configuration BPDU message. After a known time passes using such a process, only one bridge having the smallest root ID value transmits a configuration BPDU message within the network. Herein, a corresponding bridge becomes a root bridge in a corresponding network.

In the meantime, when the priorities of root IDs are equal to one another, the configuration BPDU messages are compared in a sequence of the lowest root path cost, the lowest bridge ID and the lowest port ID so as to determine their priorities.

As described above, each bridge receives a configuration BPDU message from each port, selects a root bridge, selects an optimal path to the selected root bridge, selects a Root Port (RP) having the lowest path cost up to the root bridge, and selects a Designated Port (DP) taking charge of message (frame) transfer to a corresponding segment. Remaining ports except for the RP and DP are determined as blocking ports. As illustrated in FIGS. 1 and 2, one RP and a plurality of DPs may exist in one bridge.

The STP technology as described above has been developed for application of a bridge supporting best effort traffic, but it is not suitable for AV bridging due to the following problems. This will be described in more detail with reference to FIGS. 3 to 7.

FIG. 3 is one exemplary view illustrating the general construction of an Ethernet network including a plurality of legacy Ethernet switches and synchronous Ethernet switches. As illustrated in FIG. 3, an AV bridging topology is classified as an AV cloud ensuring QoS and a legacy area not ensuring QoS. An AV cloud is an area including only switches supporting AV bridging, and an AV switch can transmit/receive synchronous packets usable for multimedia data broadcasting. FIG. 3 illustrates a state in which devices (AV devs) capable of both performing an existing Ethernet communication function and reproducing multimedia data are connected to AV switches, etc. A term “switch” may be generally considered as a device developed from a bridge, but the switch illustrated in FIG. 3, etc., is used as a term including a bridge and a switch belonging to the AV bridging topology.

FIG. 4 is one exemplary view illustrating a case in which a synchronous Ethernet switch is selected as a root bridge when a spanning tree is configured in an Ethernet network including a plurality of legacy Ethernet switches and synchronous Ethernet switches. FIG. 5 is a block diagram illustrating the Ethernet network of FIG. 4 using a spanning tree structure, and additionally shows a communication state among legacy Ethernet termination devices for descriptions about problems of FIG. 4.

The Ethernet network illustrated in FIGS. 4 and 5 may include a first and a second legacy switch 401 and 402, a first to a fourth AV switch 411 to 414, a first and a second legacy device 501 and 502 connected to the first and the second legacy switches 401 and 402, respectively, and a first to a third AV device 511 to 513 connected to the second to the fourth AV switches 412 to 414, respectively. In FIGS. 4 and 5, the first legacy switch 401 or the second legacy switch 402 is connected to the first AV switch 411, and only a connection for transmission of asynchronous packets is generally implemented between the first legacy switch 401 or the second legacy switch 402 and the first AV switch 411.

In FIGS. 4 and 5, the first AV switch 411 is selected as a root bridge. When the root bridge exists in the AV cloud as described above, it is inevitably necessary to pass through the first AV switch 411 in order to communicate with the first legacy device 501 or the second legacy device 502. In such a case, since the AV switch accommodates both time sensitive traffic (AV traffic) and best effort traffic as defined in AV browsing (synchronous Ethernet), the AV switch can partially pass through best effort traffic generated in the first legacy device 501 or the second legacy device 502. Therefore, the first AV switch 411 causes a bottleneck and thus may deteriorate the performance of an entire network.

FIG. 6 is one exemplary view illustrating a case where a legacy Ethernet switch is selected as a root bridge when a spanning tree is configured in an Ethernet network including a plurality of legacy Ethernet switches and synchronous Ethernet switches. FIG. 7 is a block diagram illustrating the Ethernet network of FIG. 6 by using a spanning tree structure, and additionally shows a communication state among AV devices for descriptions about problems of FIG. 6.

The Ethernet network illustrated in FIGS. 6 and 7 may include a first and a second legacy switch 601 and 602, a first to a fourth AV switch 611 to 614, a first and a second legacy device 701 and 702 connected to the first and the second legacy switches 601 and 602, respectively, and a first to a third AV device 711 to 713 connected to the second to the fourth AV switches 612 to 614, respectively.

In FIGS. 6 and 7, the first legacy switch 601 is selected as a root bridge. When the switch is selected as the root bridge in the legacy area as described above, it is inevitably necessary to pass through the legacy switch in order to communicate with the first AV device 711 or the second AV device 712. In such a case, communication is impossible because the legacy switch does not support AV traffic (time sensitive traffic).

### SUMMARY OF THE INVENTION

Accordingly, the present invention has been made to solve the above-mentioned problems occurring in the prior art an provides additional advantages, by providing a method for selecting a root bridge when a spanning tree is configured that can allow communication of each traffic to be efficiently performed in AV browsing (synchronous Ethernet).

According to an embodiment of the present, there is provided a method for selecting a root bridge when a spanning tree is configured in an Ethernet network including a plurality of legacy switches and a plurality of synchronous switches, the method including the steps of providing identification information in a configuration Bridge Protocol Data Unit (BPDU) message of the synchronous switch, the identification information representing that a corresponding switch is an AV switch, broadcasting configuration BPDU messages by the legacy switches and the synchronous switches and receiving configuration BPDU messages by the synchronous switch from other switches, confirming bridge priorities according to the synchronous switches through the received configuration BPDU message and the identification information to select a synchronous root bridge, receiving configuration BPDU messages by the legacy switch from other switches, and confirming bridge priorities through the received configuration BPDU messages to select a legacy root bridge.

According to another embodiment of the present, there is provided a method for selecting a root bridge in a synchronous switch when a spanning tree is configured in an Ethernet network including a plurality of legacy switches and a plurality of synchronous switches, the method including the steps of Broadcasting a configuration Bridge Protocol Data Unit (BPDU) frame including identification information at a preset hello time, the identification information representing that a corresponding switch is a synchronous switch, when configuration BPDU frames are received from other switches, determining if the identification information is confirmed from the received configuration BPDU frames, comparing a priority of the received configuration BPDU information with a priority of BPDU information of the synchronous switch, when the received configuration BPDU information has a higher priority, stopping broadcasting the configuration BPDU frame, and updating information of a network according to the received configuration BPDU information; and when the received configuration BPDU information has a lower priority, dropping corresponding received configuration BPDU frames.

### BRIEF DESCRIPTION OF THE DRAWINGS

The above features and advantages of the present invention will be more apparent from the following detailed description taken in conjunction with the accompanying drawings, in which:

FIG. 1 is one exemplary view illustrating the general construction of an Ethernet network including a plurality of bridges;

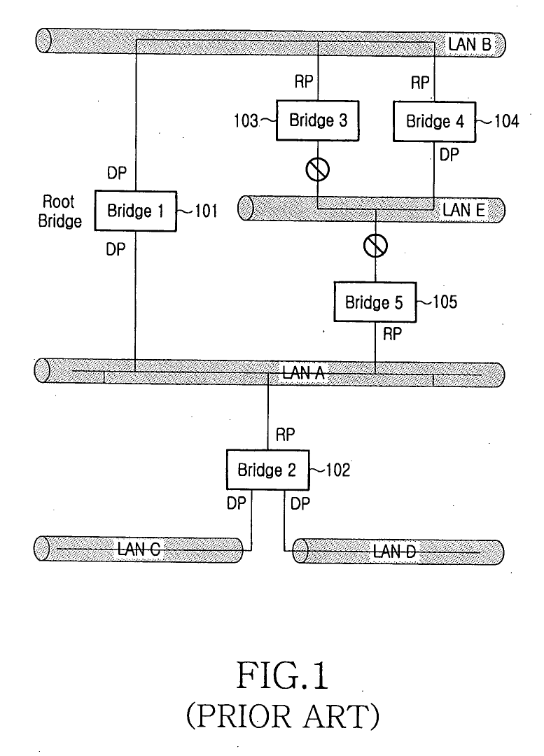

FIG. 2 is a block diagram illustrating the Ethernet network of FIG. 1 by using a spanning tree structure;

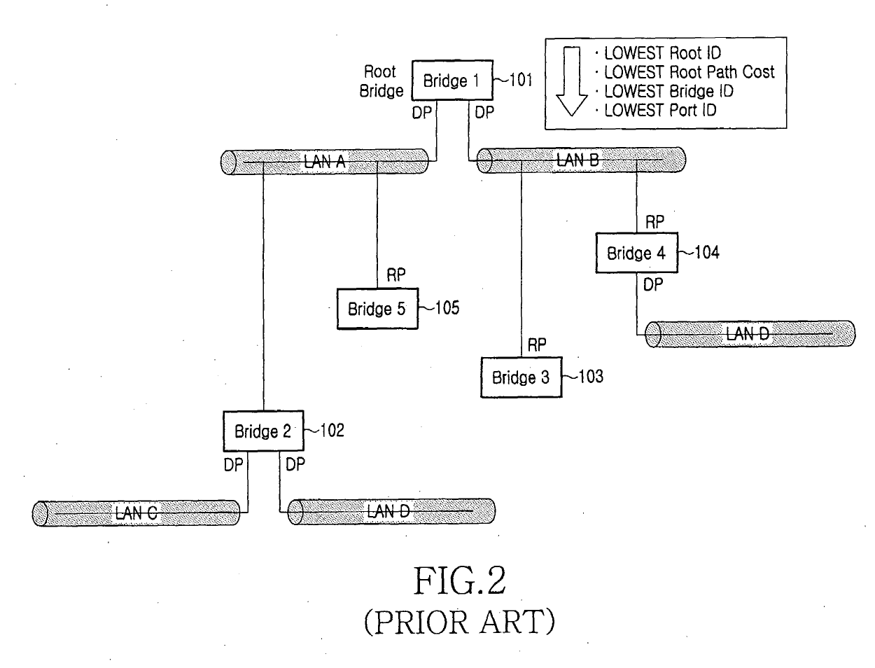

FIG. 3 is one exemplary view illustrating the general construction of an Ethernet network including a plurality of legacy Ethernet switches and synchronous Ethernet switches;

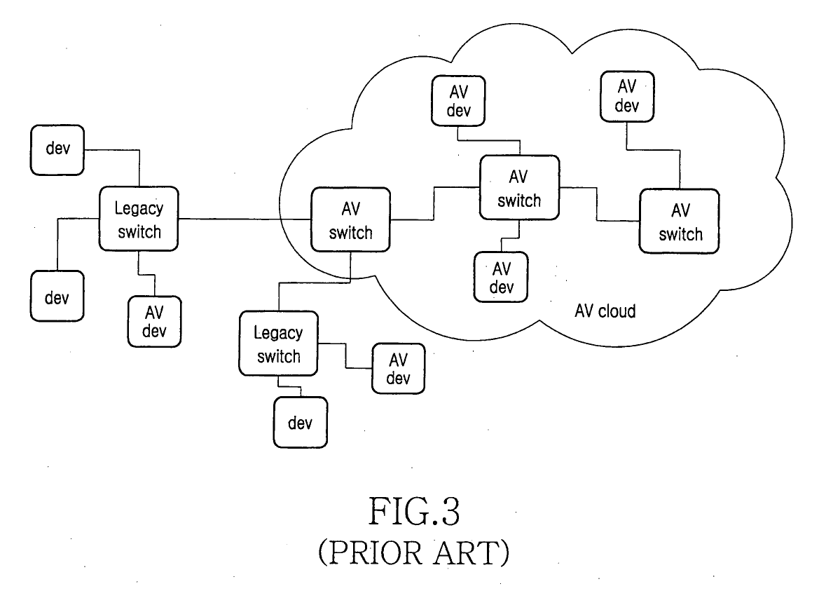

FIG. 4 is another exemplary view illustrating a case where a synchronous Ethernet switch is selected as a root bridge when a spanning tree is configured in an Ethernet network including a plurality of legacy Ethernet switches and synchronous Ethernet switches;

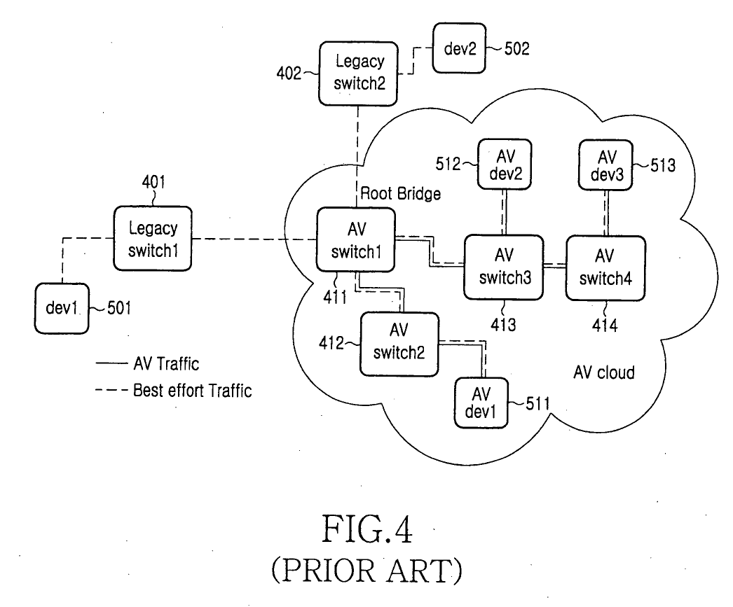

FIG. 5 is a block diagram illustrating the Ethernet network of FIG. 4 by using a spanning tree structure;

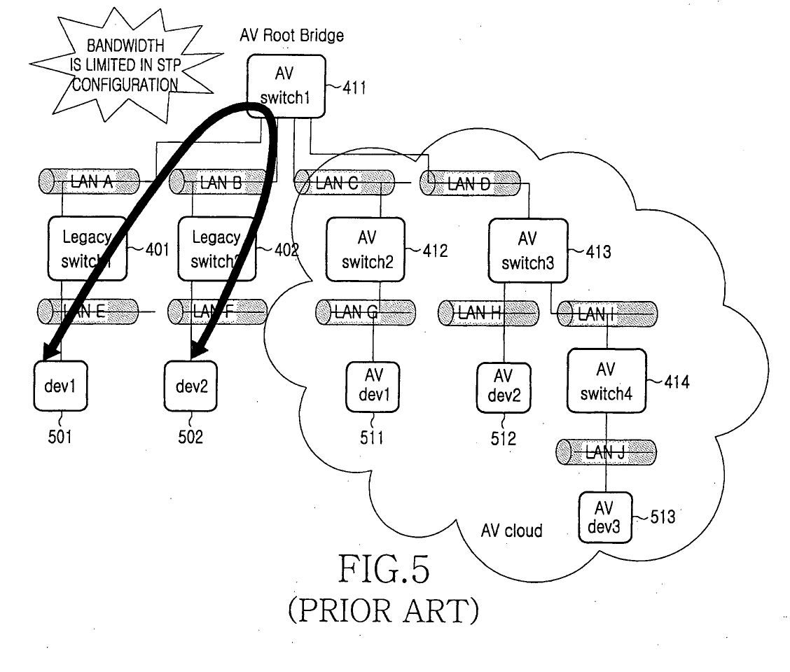

FIG. 6 is further another exemplary view illustrating a case where a legacy Ethernet switch is selected as a root bridge when a spanning tree is configured in an Ethernet network including a plurality of legacy Ethernet switches and synchronous Ethernet switches;

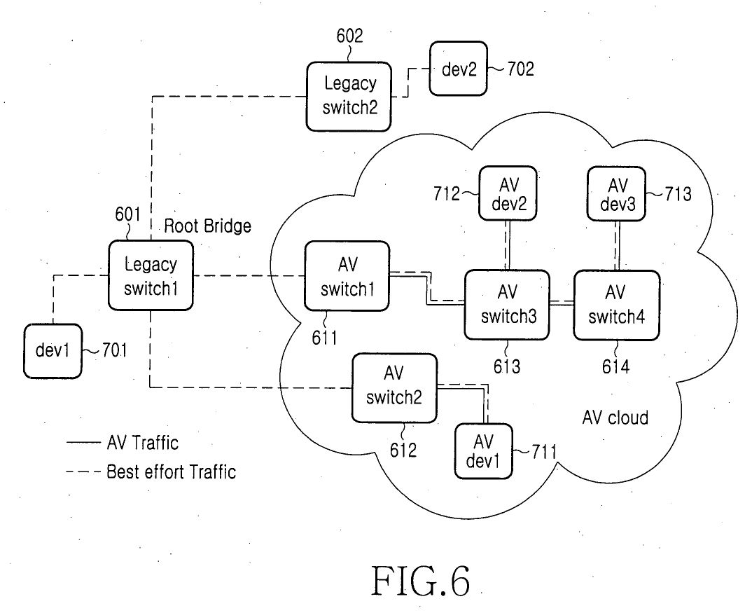

FIG. 7 is a block diagram illustrating the Ethernet network of FIG. 6 by using a spanning tree structure;

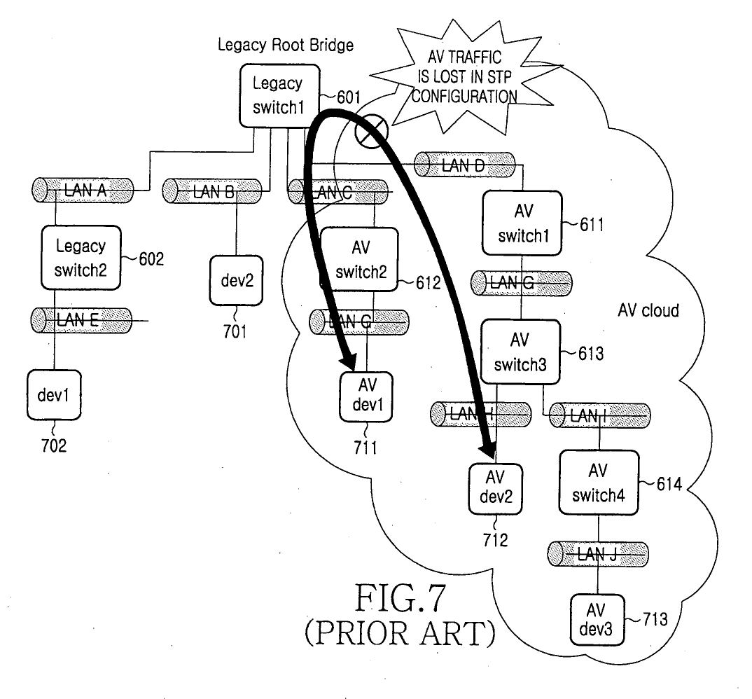

FIG. 8 is one exemplary view illustrating the general construction of an Ethernet network including a plurality of legacy Ethernet switches and synchronous Ethernet switches according to one embodiment of the present invention;

FIG. 9 is a block diagram illustrating the Ethernet network of FIG. 8 by using a spanning tree structure;

FIG. 10 is block diagram illustrating the internal construction format of a configuration BPDU frame used in the present invention;

FIG. 11 is a block diagram illustrating the internal construction of the synchronous Ethernet switch of FIGS. 8 and 9 to which the present invention is applied; and

FIG. 12 is a flow diagram illustrating an operation for root bridge selection in spanning tree configuration in a synchronous Ethernet switch according to one embodiment of the present invention.

### DETAILED DESCRIPTION

Hereinafter, an exemplary embodiment according to the present invention will be described with reference to the accompanying drawings. In the following description, many particular items, such as detailed elements, are shown, but these are provided for helping the general understanding of the present invention, and it will be understood by those skilled in the art that these particular items can be modified without departing from the spirit and scope of the present invention.

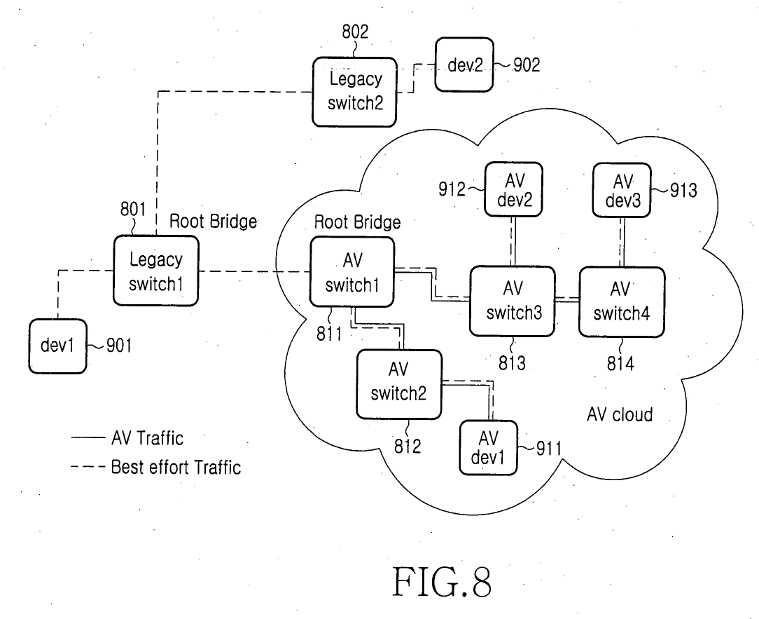

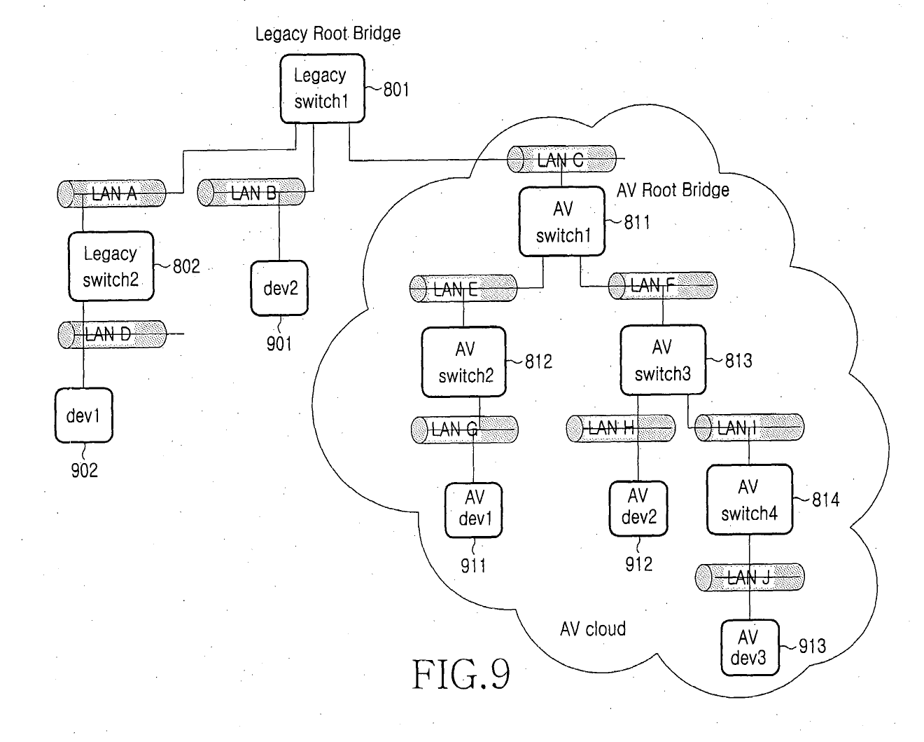

FIG. 8 is one exemplary view illustrating the general construction of an Ethernet network including a plurality of legacy Ethernet switches and synchronous Ethernet switches according to one embodiment of the present invention. FIG. 9 is a block diagram illustrating the Ethernet network of FIG. 8 by using a spanning tree structure. The Ethernet network of FIGS. 8 and 9 according to one embodiment of the present invention may include a first and a second legacy switch 801 and 802, a first to a fourth AV switch 811 to 814, a first and a second legacy device 901 and 902 connected to the first and the second legacy switches 801 and 802, respectively, and a first to a third AV device 911 to 913 connected to the second to the fourth AV switches 812 to 814, respectively. In FIGS. 8 and 9, the first legacy switch 801 or the second legacy switch 802 is connected to the first AV switch 811, and only a connection for transmission of asynchronous packets is generally implemented between the first legacy switch 801 or the second legacy switch 802 and the first AV switch 811.

As illustrated in FIGS. 8 and 9, in the Ethernet network according to the present invention, two root bridges (the first AV switch 811 and the first legacy switch 801 in FIGS. 8 and 9) are selected in an AV cloud and a legacy area, respectively. In such a case, two spanning trees for time sensitive traffic and best effort traffic are configured as illustrated in FIG. 9. In this way, if two spanning trees are configured, i.e. if both a spanning tree for time sensitive traffic and a spanning tree for best effort traffic are configured, the first legacy switch 801 becomes a root bridge in communication between the legacy devices 901 and 902. In such a configuration, performance deterioration of a network due to a bottleneck does not occur because an AV switch is not included within a corresponding spanning tree. Further, in communication among the AV devices 911 to 913, for example, since a spanning tree in which the first AV switch 811 becomes a root bridge is implemented, communication error does not occur. In this way, the scheme based on the present invention is applied, so that it is possible to construct a network capable of optimizing and processing both time sensitive traffic and best effort traffic.

As described above, in order to select respective root bridges in the AV cloud and the legacy area, the first and the second legacy switches 801 and 802 and the first to the fourth AV switches 811 to 814 of the present invention perform the following procedure. First, specific information for representing that a corresponding switch is an AV switch is provided in a BPDU message. In one aspect of the invention, the specific information representing the corresponding switch as an AV switch is provided in advance. Such specific information includes a root ID with the first priority for comparison, which is set as a predetermined specific value in selection of a root bridge, thereby allowing a corresponding switch to be identified as an AV switch.

In such a case, using the fact that a root ID having a lower value than others is selected as a root bridge, when a switch exists in an AV cloud, a root ID value is set as a value higher than 0X8000 (a minimum basic recommended value), such as 0XFFFF so as to use it as a value for identifying an AV switch. In this case, one of the legacy switches is primarily selected as a root bridge according to the conventional root bridge selection procedure without applying separate modification to the conventional root bridge selection procedure. That is, when a legacy root bridge is selected, since the specific root ID determined for an AV bridge has a high value (e.g. 0XFFFF), the legacy bridges drop this value when received through a BPDU message. As a result, a bridge having a low root ID value is selected as a root bridge from the legacy bridges.

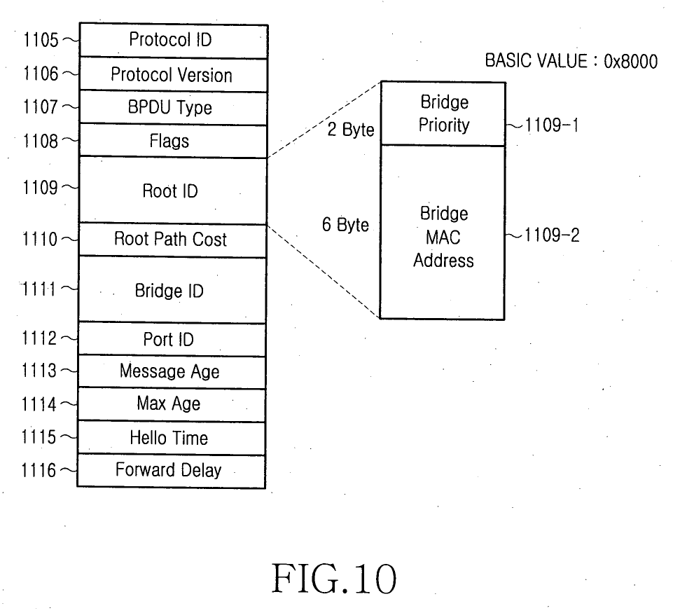

FIG. 10 is block diagram illustrating the internal construction format of a configuration BPDU frame used in the present invention. Referring to FIG. 10, a configuration BPDU frame proposed in an IEEE 802.1D protocol includes a “protocol ID” area 1105, a “protocol version” area 1106, a “BPDU type” area 1107, a “flags” area 1108, a “root ID” area 1109, a “root path cost” area 1110, a “bridge ID” area 1111, a “port ID” area 1112, a “message age” area 1113, a “MAX age” area 1114, a “hello time” area 1115, and a “forward delay” area 1116. The “protocol ID” area 1105 stores information for identifying protocols, the “protocol version” area 1106 stores information about the version of a protocol, the “BPDU type” area 1107 stores information about a BPDU type, and the “flags” area 1108 stores information about a flag. The “root ID” area 1109 stores information about a root identifier, the “root path cost” area 1110 stores information about root path cost, the “bridge ID” area 1111 stores information about a bridge identifier, and the “port ID” area 1112 stores information about a port identifier. The “message age” area 1113 stores information about a message age, the “MAX age” area 1114 stores information about a maximum age, the “hello time” area 1115 stores information about a hello time, and the “forward delay” area 1116 stores information about a forward delay.

The “root ID” area 1109 includes a “bridge priority” area 1109-1 of two bytes for storing information about a bridge priority and a “bridge MAC address” area 1109-2 of eight bytes for storing information about a bridge MAC address. The bridge priority is a value adjustable by a manager, and the bridge MAC address uses one of the port MAC addresses of a bridge. The bridge priority has a basic value of 0X8000, and the number 1 port MAC address is recommended as the basic value of the bridge MAC address.

According to the embodiment of the present invention, in the BPDU frame having the construction as described above, a value higher than 0X8000 (a minimum basic recommended value) such as 0XFFFF is set in the bridge priority” area 1109-1 of two bytes for storing information about a bridge priority, and this can be used as a value for identifying an AV switch.

As described above, the specific information is provided in advance in the BPDU message in order to select respective root bridges in the AV cloud and the legacy area, and then each of the AV switches confirms AV switch identification information within corresponding BPDU messages, confirms bridge priorities according to AV switches, and performs a root bridge selection operation. Herein, in a case where each of the AV switches has set a root ID to have a value of a specific value such as 0XFFFF as AV switch identification information, the AV switches have the same root ID value. Accordingly, each of the AV switches compare the BPDU messages in a sequence of the lowest root path cost, the lowest bridge ID and the lowest port ID, which is the subsequent step of bridge priority determination, thereby selecting an AV root bridge.

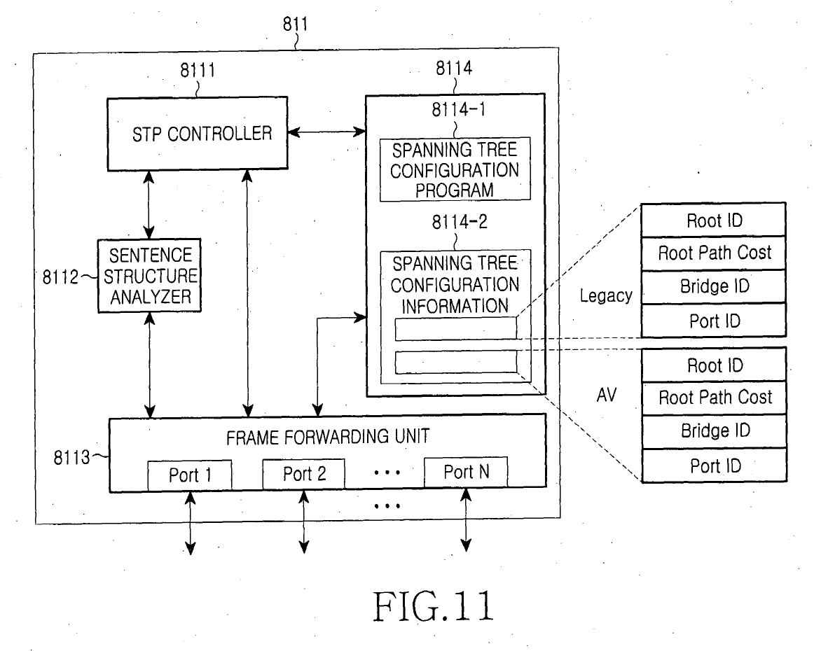

FIG. 11 is a block diagram illustrating the internal construction of a synchronous Ethernet switch (AV switch) to which the present invention is applied, and representatively discloses the construction of the first AV switch 811. For convenience of description, FIG. 11 discloses function units related to the processing of a configuration BPDU message. Referring to FIG. 11, the first AV switch 811 to which the present invention is applied includes a frame forwarding unit 8113, a sentence structure analyzer 8112, a memory unit 8114, and an STP controller 8111. The frame forwarding unit 8113 includes a plurality of ports, a frame storage queue, etc., to transmit/receive Ethernet frames to/from other switches connected through a LAN. The sentence structure analyzer 8112 analyzes the sentence structure of frames received in the frame forwarding unit 8113, and transfers a configuration BPDU frame to the STP controller 8111. The memory unit 8114 stores a configuration parameter related to a network, and stores operation programs of the STP controller 8111, etc. The STP controller 8111 generally controls these function units to perform an operation for configuring a spanning tree.

The memory unit 8114 may be an aggregation of core system memories or memory elements, which may store a spanning tree configuration program 8114-1 and spanning tree configuration information 8114-2 for the operation of the STP controller 8111. In addition, the memory unit 8114 includes a forwarding table (not shown), which is referred to by the frame forwarding unit 8113, etc. The spanning tree configuration information 8114-2 is information related to spanning tree configuration, and the memory unit 8114 updates and stores configuration BPDU information of both a legacy switch having the highest priority and an AV switch having the highest priority when a root bridge is selected according to characteristics of the present invention, as well as its own priority information stored in advance for root bridge selection.

The STP controller 8111 confirms the configuration BPDU message, which is received in the frame forwarding unit 8113, through the sentence structure analyzer 8112 for root bridge selection, and continues to update the configuration BPDU information of the legacy switch having the highest priority. Further, the STP controller 8111 confirms AV switch identification information within the configuration BPDU message through the sentence structure analyzer 8112, continues to update the configuration BPDU information of the AV switch having the highest priority, and selects respective root bridges from legacy switches and AV switches.

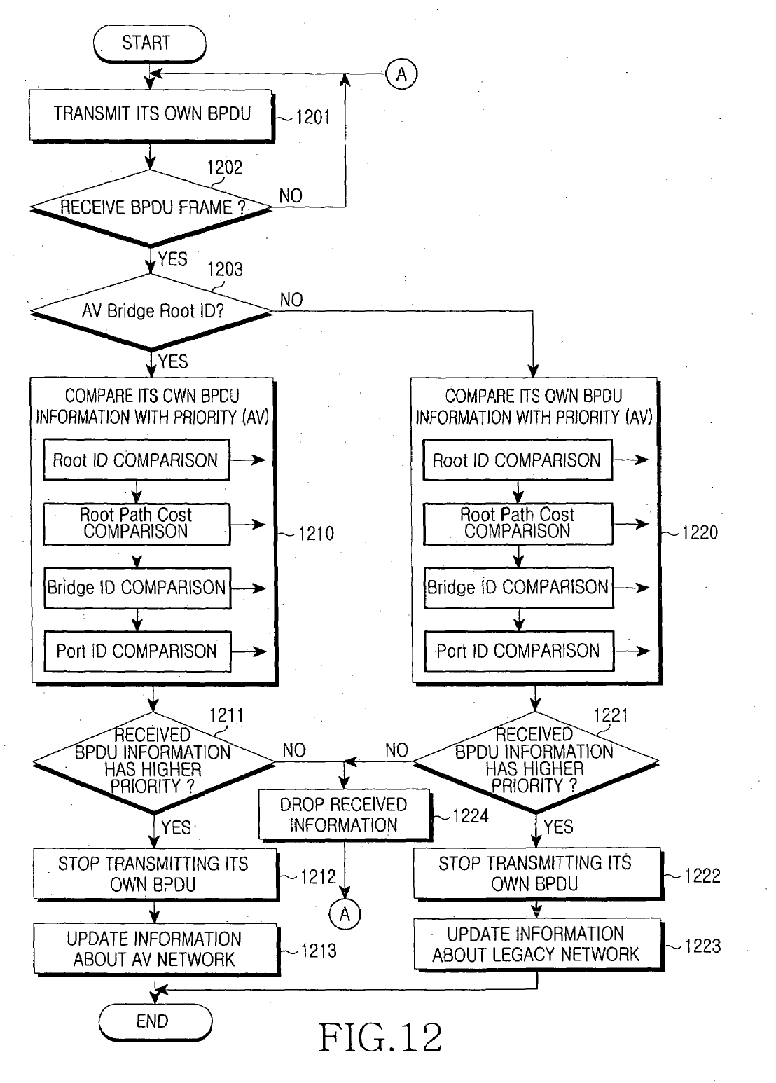

FIG. 12 is a flow diagram illustrating an operation for root bridge selection in spanning tree configuration in a synchronous Ethernet switch (AV switch) according to one embodiment of the present invention. Hereinafter, the root bridge selection operation in the AV switch according to one embodiment of the present invention will be described with reference to FIG. 12. For root bridge selection, in step 1201, the AV switch transmits (broadcasts) its own configuration BPDU message through all ports at a preset hello time (basic value is two seconds). When a configuration BPDU message is received from a different switch, the AV switch confirms the received configuration BPDU frame in step 1202.

In step 1203, the AV switch determines if identification information used for identifying an AV switch is confirmed in a corresponding received configuration BPDU frame. For example, this is a step for determining if a root ID value is 0XFFFF, and it may be determined that the corresponding configuration BPDU frame relates to an AV switch. In step 1203, if the identification information used for identifying an AV switch is confirmed in the corresponding received configuration BPDU frame, step 1210 is performed. Otherwise, step 1220 is performed.

In step 1220, the AV switch compares the priority of the received configuration BPDU information with the priority of its own BPDU information in order to select a legacy root bridge. In step 1220, the AV switch determines a priority by comparing two types of BPDU information in a sequence of a root ID, root path cost, a bridge ID, and a port ID. In step 1221, if the received configuration BPDU information has a higher priority as a result of the comparison in step 1220, step 1222 is performed. Otherwise, step 1224 is performed.

In step 1222, the AV switch stops transmitting its own configuration BPDU information. In step 1223, the AV switch updates information about a legacy network (i.e. updates the value of a BPDU received up to now and having the highest priority). In step 1224, the AV switch drops corresponding received information because the received BPDU information has a lower priority, and repeats the above-described steps after returning to step 1201.

In step 1210, the AV switch compares the priority of the received configuration BPDU information with the priority of its own BPDU information in order to select an AV root bridge. Similarly to step 1220, in step 1210, the AV switch determines a priority by comparing two types of BPDU information in a sequence of a root ID, root path cost, a bridge ID, and a port ID. However, in the embodiment of the present invention, when a root ID has been set to have a specific value such as 0XFFFF as AV switch identification information, AV switches have the same root ID value. Accordingly, the AV switch compares the priorities by comparing corresponding BPDU information in a sequence of the lowest root path cost, the lowest bridge ID and the lowest port ID, which is the subsequent step of bridge priority determination. In step 1211, if the received BPDU information has a higher priority as a result of the comparison in step 1210, step 1212 is performed. Otherwise, step 1224 is performed.

In step 1212, the AV switch stops transmitting its own configuration BPDU information. In step 1223, the AV switch updates information about an AV network (i.e. updates the value of a BPDU received up to now and having the highest priority).

As illustrated in FIG. 12, the operation for root bridge selection in the spanning tree configuration in the AV switch can be performed. Herein, each AV switch continues to receive a configuration BPDU message from a different switch even after stopping the transmission of its own configuration BPDU message, compares the received configuration BPDU message with the stored configuration BPDU information with the highest priority, and continues to perform an operation for updating the information about the legacy network or AV network. Once a certain time passes through such a process, only two switches, i.e. a legacy switch with the highest priority and an AV switch with the highest priority, transmit configuration BPDU information, so that root bridges are selected.

According to the present invention as described above, when implementing AV bridging being currently conducted in an IEEE 802.1, a scheme for root bridge selection in spanning tree configuration is compatible with an existing STP, and solves both a bottleneck, which may be caused by processing of best effort traffic when an AV switch is selected as a root bridge, and the inability to process AV traffic when a legacy switch is selected as a root bridge, so that it is possible to prevent the conventional unreasonable topology and improve the efficiency of a synchronous Ethernet network.

The above-described methods according to the present invention can be realized in hardware or as software or computer code that can be stored in a recording medium such as a CD ROM, a RAM, a ROM, a floppy disk, a hard disk, or a magneto-optical disk or downloaded over a network, so that the methods described herein can be executed by such software or computer code using a general purpose computer, or a special processor or in programmable hardware, such as an ASIC or FPGA, or dedicated hardware. As would be understood in the art, the computer, the processor or the programmable hardware include memory components, e.g., RAM, ROM, Flash, etc. that may store or receive software or computer code which when accessed and executed by the computer, processor or hardware implement the processing methods described herein.

Although a preferred embodiment of the present invention have been described for illustrative purposes, those skilled in the art will appreciate that various modifications, additions and substitutions are possible, without departing from the scope and spirit of the invention as disclosed in the accompanying claims, including the full scope of equivalents thereof. For example, in the above description, a root ID may have a value of 0XFFFF as identification information for identifying an AV switch. However, other root ID values may be set as corresponding identification information.

What is claimed is:

1. A method for selecting a root bridge when a spanning tree is configured in an Ethernet network including a plurality of legacy switches and a plurality of synchronous switches, the method comprising the steps of:
providing identification information in a configuration Bridge Protocol Data Unit (BPDU) message of the synchronous switch, the identification information representing that a corresponding switch is an AV switch;
broadcasting configuration BPDU messages by the legacy switches and the synchronous switches; and
receiving configuration BPDU messages by the synchronous switch from other switches, confirming bridge priorities according to the synchronous switches through the received configuration BPDU message and the identification information to select a synchronous root bridge, receiving configuration BPDU messages by the legacy switch from other switches, and confirming bridge priorities through the received configuration BPDU messages to select a legacy root bridge.

2. The method as claimed in claim 1, wherein, in the identification information, a root ID has a preset value.

3. The method as claimed in claim 2, wherein the identification information has a value at least higher than 0X8000.

4. The method as claimed in claim 1, wherein the step of selecting the synchronous root bridge comprises the steps of:
when a priority of the synchronous switch is lower than priorities of the received configuration BPDU message, updating information of a network by the synchronous switch according to the corresponding received configuration BPDU messages, and stopping broadcasting its own configuration BPDU message; and
when the priority of the synchronous switch is higher than priorities of the received configuration BPDU messages, dropping by the synchronous switch the received configuration BPDU messages.

5. The method as claimed in claim 1, wherein the step of selecting the legacy root bridge comprises the steps of:
when a priority of the legacy switch is lower than priorities of the received configuration BPDU message, updating information of a network by the legacy switch according to the corresponding received configuration BPDU messages, and stopping broadcasting its own configuration BPDU message; and
when the priority of the synchronous switch is higher than priorities of the received configuration BPDU messages, dropping by the legacy switch the received configuration BPDU messages.

6. The method as claimed in claim 1, wherein the priority is determined in a sequence of a lowest root ID, a lowest root path cost, a lowest bridge ID and a lowest port ID.

7. At method for selecting a root bridge in a synchronous switch when a spanning tree is configured in an Ethernet network including a plurality of legacy switches and a plurality of synchronous switches, the method comprising the steps of:
broadcasting, in advance, a configuration Bridge Protocol Data Unit (BPDU) frame including identification information at a preset hello time, the identification information representing that a corresponding switch is a synchronous switch;
when configuration BPDU frames are received from other switches, determining if the identification information is confirmed from the received configuration BPDU frames;
comparing a priority of the received configuration BPDU information with a priority of BPDU information of the synchronous switch;
when the received configuration BPDU information has a higher priority, stopping broadcasting the configuration BPDU frame, and updating information of a network according to the received configuration BPDU information; and
when the received configuration BPDU information has a lower priority, dropping corresponding received configuration BPDU frames.

8. The method as claimed in claim 7, further comprising a step of continuing to receive the configuration BPDU frames from other switches even after stopping broadcasting the configuration BPDU frame, and continuing to update information of the network according to the received configuration BPDU frames.

9. The method as claimed in claim 7, wherein, in the identification information, a root ID has a preset value.

10. The method as claimed in claim 7, wherein the identification information has a value at least higher than 0X8000.

11. The method as claimed in claim 8, wherein the priority is determined in a sequence of a lowest root ID, a lowest root path cost, a lowest bridge ID and a lowest port ID.

12. An apparatus for selecting a root bridge when a spanning tree is configured in an Ethernet network including a plurality of legacy switches and a plurality of synchronous switches, the apparatus comprising:
a processor in communication with a memory, the processor executing computer code instructing the processor to execute the steps of:
providing identification information in a configuration Bridge Protocol Data Unit (BPDU) message of the synchronous switch, the identification information representing that a corresponding switch is an AV switch;
broadcasting configuration BPDU messages by the legacy switches and the synchronous switches; and
receiving configuration BPDU messages by the synchronous switch from other switches, confirming bridge priorities according to the synchronous switches through the received configuration BPDU message and the identification information to select a synchronous root bridge, receiving configuration BPDU messages by the legacy switch from other switches, and confirming bridge priorities through the received configuration BPDU messages to select a legacy root bridge.

13. The apparatus as claimed in claim 12, wherein, in the identification information, a root ID has a preset value.

14. The apparatus as claimed in claim 13, wherein the identification information has a value at least higher than 0X8000.

15. The apparatus as claimed in claim 12, wherein the step of selecting the synchronous root bridge comprises the steps of:
when a priority of the synchronous switch is lower than priorities of the received configuration BPDU message, updating information of a network by the synchronous switch according to the corresponding received configuration BPDU messages, and stopping broadcasting its own configuration BPDU message; and
when the priority of the synchronous switch is higher than priorities of the received configuration BPDU messages, dropping by the synchronous switch the received configuration BPDU messages.

16. The apparatus as claimed in claim 12, wherein the step of selecting the legacy root bridge comprises the steps of:
when a priority of the legacy switch is lower than priorities of the received configuration BPDU message, updating information of a network by the legacy switch according to the corresponding received configuration BPDU messages, and stopping broadcasting its own configuration BPDU message; and
when the priority of the synchronous switch is higher than priorities of the received configuration BPDU messages, dropping by the legacy switch the received configuration BPDU messages.

17. The apparatus as claimed in claim 12, wherein the priority is determined in a sequence of a lowest root ID, a lowest root path cost, a lowest bridge ID and a lowest port ID.

18. The apparatus as claimed in claim 12, further comprising:
an input/output device in communication with the processor.

19. The apparatus as claimed in claim 12, wherein the computer code is stored in the memory.
